(19) United States
(12) Patent Application Publication
(10) Pub. No.: US 2020/0406828 A1
(43) Pub. Date: Dec. 31, 2020

(54) MULTIFUNCTION ARTICULATING SPORT BAR

(71) Applicant: GM GLOBAL TECHNOLOGY OPERATIONS LLC, Detroit, MI (US)

(72) Inventors: Matthew Simonin, Ortonville, MI (US); Joseph M. Polewarczyk, Rochester Hills, MI (US); Craig A. Kollar, Sterling Heights, MI (US)

(21) Appl. No.: 16/451,425

(22) Filed: Jun. 25, 2019

(51) Int. Cl. B60R 9/06; B62D 33/02; B62D 33/023; B62D 33/06; B62D 43/02

(52) U.S. Cl. CPC B60R 9/06; B62D 33/0207; B60R 9/10; B62D 33/06; B62D 43/02; B62D 33/023

(57) ABSTRACT

A vehicle includes a cab with a window and a cargo area with first and second sidewalls proximate the cab. A first accessory member is coupled to the first sidewall and the second sidewall and extends about a portion of a periphery of the window. A second accessory member includes a first leg member, a second leg member, and a horizontal member. A first leg member proximal end is coupled to the first sidewall, and a second leg member proximal end is coupled to the second sidewall. The horizontal member couples a first leg member distal end to a second leg member distal end. The second accessory member is pivotable between first, second, and third positions relative to the cargo area.

### INTRODUCTION

Pick-ups and utility vehicles are often provided with a bed or cargo bay for transporting cargo. A variety of accessories are available for utilizing the cargo space. For example, bed dividers can be purchased as an after-market item. As another example, so-called “headache racks” are available to protect the rear glass proximate the cargo bay. Ladder racks are also commercially available. While useful, these items are often expensive. Moreover, each of these must be purchased as separate items. When not in use, these items must generally be removed from the vehicle and stored off-board. Storing multiple such accessories may occupy a significant amount of space.

### SUMMARY

A vehicle according to the present disclosure includes a cab having a window. The vehicle also includes a cargo area proximate the cab. The cargo area has a first sidewall and a second sidewall. The vehicle additionally includes a first accessory member coupled to the first sidewall and the second sidewall. The first accessory member extends about a portion of a periphery of the window. The vehicle further includes a second accessory member pivotably coupled to the first sidewall and the second sidewall. The second accessory member includes a first leg member, a second leg member, and a horizontal member. The first leg member has a first leg member proximal end and a first leg member distal end, and the second leg member has a second leg member proximal end and a second leg member distal end. The first leg member proximal end is coupled to the first sidewall, and the second leg member proximal end is coupled to the second sidewall. The horizontal member couples the first leg member distal end to the second leg member distal end. The second accessory member is pivotable between first, second, and third positions relative to the cargo area. In the first position the horizontal member is disposed proximate the first accessory member, in the second position the first leg member and the second leg member extend generally parallel to the first sidewall and the second sidewall, respectively, and the third position is intermediate the first and second positions.

In an exemplary embodiment, the vehicle additionally includes a grid member having a first grid panel and a second grid panel with a folding interface therebetween. The first grid panel is coupled to the first accessory member, and the second grid panel is coupled to the second accessory member.

In an exemplary embodiment, the vehicle additionally includes a roller member rotatably coupled to the horizontal member.

In an exemplary embodiment, the vehicle additionally includes a tire storage member coupled to the second accessory member.

In an exemplary embodiment, the first leg member comprises a first articulated connection proximate the first leg member proximal end, and the second leg member comprises a second articulated connection proximate the second leg member proximal end. The second accessory member is pivotably coupled to the first sidewall and the second sidewall via the first articulated connection and second articulated connection, respectively. Such embodiments may include a first engagement member associated with the first articulated connection and a second engagement member associated with the second articulated connection. The first engagement member and second engagement member are configured to selectively retain the second accessory member in a desired position among the first position, the second position, and the third position. Such embodiments may also include a first clock spring associated with the first articulated connection and a second clock spring associated with the second articulated connection.

An accessory for a vehicle includes first and second tubular members. The first tubular member is configured to couple to first and second sidewalls of a cargo area. The first tubular member has a first leg member, a second leg member, and a first horizontal member coupling the first leg member to the second leg member. The second tubular member is configured to couple to first and second sidewalls of a cargo area spaced from the first tubular member. The second tubular member includes a third leg member, a fourth leg member, and a second horizontal member. The third leg member has a third leg member proximal end, a third leg member distal end, and a first articulated connection disposed between the third leg member proximal end and the third leg member distal end. The fourth leg member has a fourth leg member proximal end, a fourth leg member distal end, and a second articulated connection disposed between the third leg member proximal end and the third leg member distal end. The second horizontal member couples the third leg member distal end to the fourth leg member distal end. The second tubular member is pivotable between first, second, and third positions about the first and second articulated connections. In the first position the second horizontal member is disposed proximate the first tubular member, in the second position the third leg member and the fourth leg member extend generally orthogonal to the first leg member and the second leg member, respectively, and the third position is intermediate the first and second positions.

In an exemplary embodiment, the accessory additionally includes a grid member having a first grid panel and a second grid panel with a folding interface therebetween. The first grid panel is coupled to the first tubular member, and the second grid panel is coupled to the second tubular member.

In an exemplary embodiment, the accessory additionally includes a roller member rotatably coupled to the second horizontal member.

In an exemplary embodiment, the accessory additionally includes a tire storage member coupled to the second tubular member.

In an exemplary embodiment, the accessory additionally includes a first engagement member associated with the first articulated connection and a second engagement member associated with the second articulated connection. The first engagement member and second engagement member are configured to selectively retain the second tubular member in a desired position among the first position, the second position, and the third position.

In an exemplary embodiment, the accessory additionally includes a first clock spring associated with the first articulated connection and a second clock spring associated with the second articulated connection.

As may be seen, the present disclosure provides a multi-function accessory capable of fulfilling multiple functional roles, and moreover does so via an easily reconfigurable assembly. The above and additional advantages will be made clear in the description below and accompanying drawings.

### BRIEF DESCRIPTION OF THE DRAWINGS

FIG. 1 is an illustration of a vehicle having an accessory according to an embodiment of the present disclosure;

FIGS. 2A-2C illustrate operation of an embodiment of an accessory according to an embodiment of the present disclosure;

FIGS. 3A-3C illustrate a second embodiment of an accessory according to the present disclosure;

FIG. 4 illustrates a third embodiment of an accessory according to the present disclosure;

FIGS. 5A-5B illustrate a fourth embodiment of an accessory according to the present disclosure;

FIGS. 6A-6B illustrate a fifth embodiment of an accessory according to the present disclosure;

FIGS. 7A-7B illustrate a sixth embodiment of an accessory according to the present disclosure; and

FIG. 8 illustrates a seventh embodiment of an accessory according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

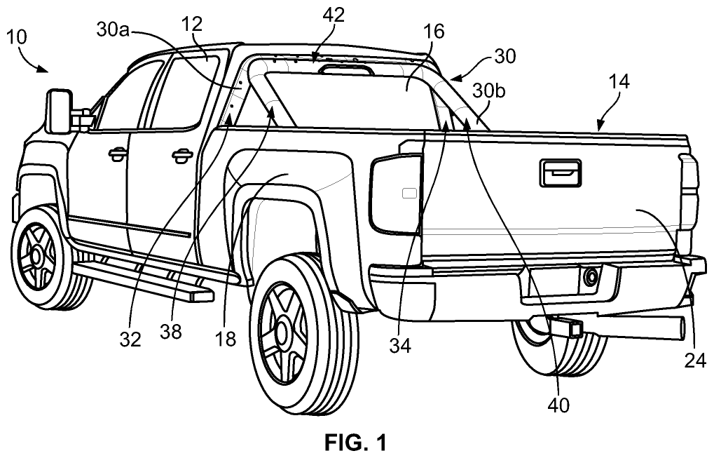

Referring now to FIG. 1, a vehicle 10 is illustrated. The vehicle 10 is provided with a cabin 12 for transporting occupants and with a cargo bay 14, which may alternatively be referred to as a bed or tonneau, for transporting cargo. An aft window 16 is positioned between the cabin 12 and the cargo bay 14.

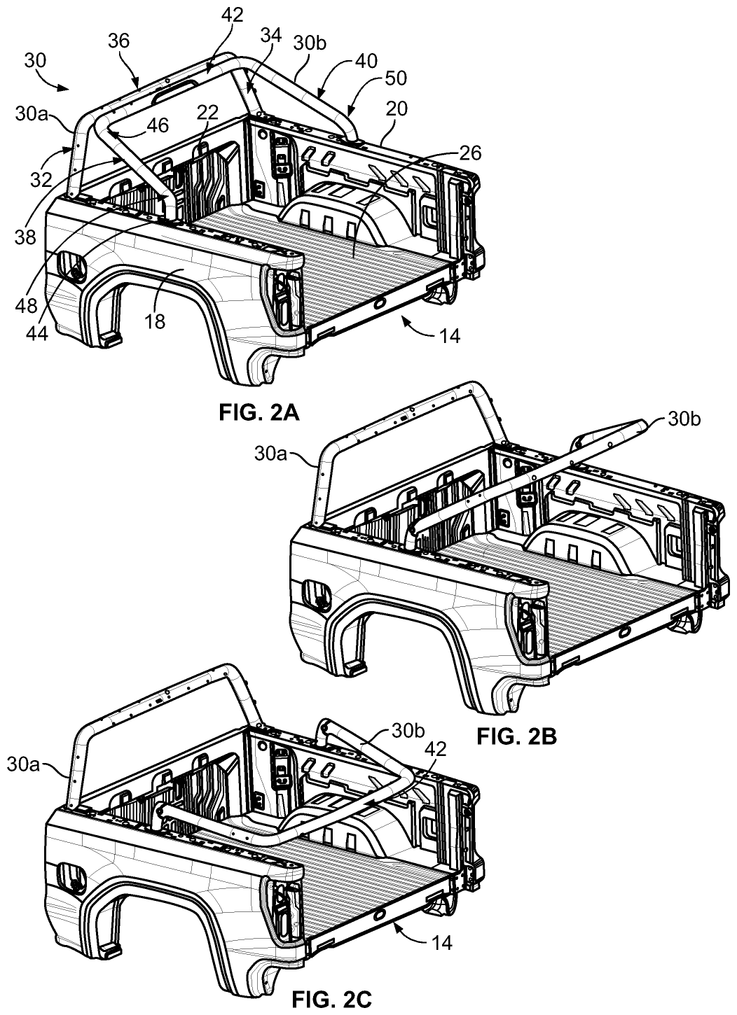

In this exemplary embodiment, as shown in further detail in FIGS. 2a-2c, the cargo bay 14 is bounded by a left sidewall 18, a right sidewall 20, a fore sidewall 22, an aft sidewall 24, and a floor 26. In this exemplary embodiment the fore sidewall 22 is defined by an aft portion of the cabin 12 and the aft sidewall 24 is defined by a pivotable endgate. The left and right sidewalls 18, 20 extend generally longitudinally, i.e. generally parallel to a fore-aft axis of the vehicle 10. In an exemplary embodiment, the left and right sidewalls 18, 20 are provided with a plurality of apertures or ports within which accessories may be retained. The fore and aft sidewalls 22, 24 extend generally laterally, i.e. generally parallel to a side-side axis of the vehicle 10.

An accessory 30, which may alternatively be referred to as a sport bar, is coupled to the left sidewall 18 and to the right sidewall 20. The sport bar 30 includes a fore member 30a and an aft member 30b.

The fore member 30a comprises a first leg 32, a second leg 34, and a top bar 36. The first leg 32 is coupled to the left sidewall 18, the second leg 34 is coupled to the right sidewall 20, and the top bar 36 couples upper portions of the first leg 32 and second leg 34. In the illustrated embodiment, fore member 30a is a single rigid component comprising the first leg 32, second leg 34, and top bar 36; however, in other embodiments the fore member 30a may be comprise a plurality of discrete components. In the illustrated embodiment, the first and second legs 32, 34 are fixedly coupled to the left and right sidewalls 18, 20, respectively, proximate the fore sidewall 22. In an exemplary embodiment, the first and second legs 32, 34 are fixedly coupled to the left and right sidewalls 18, 20, respectively, by fixation to aforementioned apertures or ports in the left and right sidewalls 18, 20, e.g. via fasteners. The first leg 32, second leg 34, and top bar 36 thereby define a rigid frame extending about at least a portion of the periphery of the window 16.

The aft member 30b comprises a first leg 38, a second leg 40, and a top bar 42. The first leg 38 is coupled to the left sidewall 18 aft of the first leg 32, the second leg 40 is coupled to the right sidewall 20 aft of the second leg 34, and the top bar 42 couples distal ends of the first leg 38 and second leg 40. The first leg 38 has a proximal end 44, a distal end 46, and is pivotably coupled to the left sidewall 18 via a first pivoting connection 48. In the illustrated embodiment, the proximal end 44 is fixedly coupled to the left sidewall 18 and the pivoting connection 48 is provided as a hinged portion within the first leg 38 proximate the proximal end 44. However, in other embodiments, other pivoting connections may be provided, e.g. as a pivoting interface between the proximal end 44 and the left sidewall 18. The second leg 40 is provided with a second pivoting connection 50, which is arranged generally as a mirror of the first pivoting connection 48.

The aft member 30b is selectively pivotable among at least three distinct positions. In a forward position, as illustrated in FIG. 2a, the top bar 42 of the aft member 30b is disposed proximate the top bar 36 of the fore member 30a. In an aft position, illustrated in FIG. 2c, the first leg 38 and second leg 40 of the aft member 30b extend generally longitudinally to position the top bar 42 proximate an aft portion of the storage bay 14. In an intermediate position, illustrated in FIG. 2b, the aft member 30b is disposed at an intermediate position between the forward and aft positions. In the intermediate position, the top bar 42 of the aft member 30b is preferably disposed at approximately the same height as the top bar 46 of the fore member 30a. As will be discussed in further detail below, the aft member 30b and fore member 30a may thereby cooperate to perform a variety of functions in the various positions.

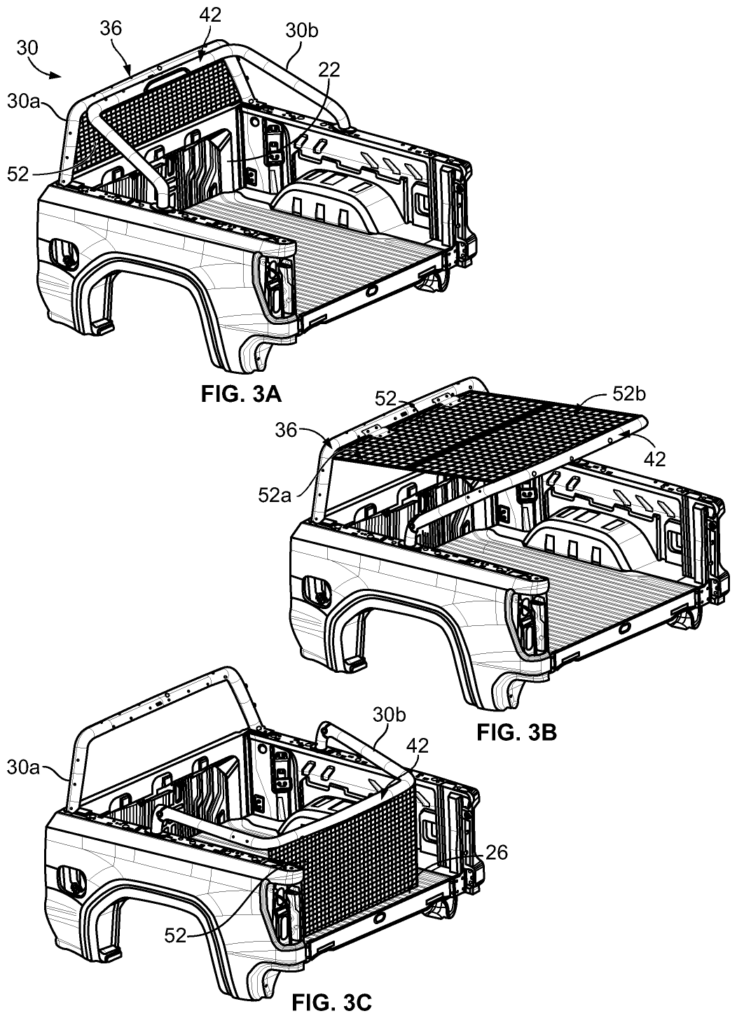

Referring now to FIGS. 3a-3c, the accessory 30 may be provided with a grid member or grate 52. In an exemplary embodiment, the grid member 52 comprises a first grid panel 52a and a second grid panel 52b, with a hinge interface therebetween. The first grid panel 52a and second grid panel 52b are preferably each approximately the same size and shape as the aft window 16. The first grid panel 52a is secured to the top bar 36 fore member 30a and the second grid panel 52b is secured to the top bar 42 of the aft member 30b. The grid member 52 is preferably formed of a relatively rigid material such as metal or a rigid plastic.

When the aft member 30b is disposed in the forward position, as illustrated in FIG. 3a, the grid member 52 may hingedly fold with the second grid panel 52b superposed over the first grid panel 52a, which is in turn superposed over the aft window 16. The grid member 52 may optionally be secured to the fore sidewall 22 to retain the grid member 52 in such a position. The grid member 52 may thereby function as a so-called “headache rack”, protecting the aft window 16 and any occupants of the cabin 12 from objects in the cargo bay 14.

When the aft member 30b is disposed in the intermediate position, as illustrated in FIG. 3b, the grid member 52 may unfold and function as a roof rack extending between the top bar 36 of the fore member 30a and the top bar 42 of the aft member 30b.

When the aft member 30b is disposed in the aftward position, as illustrated in FIG. 3c, the first panel 52a may be disengaged from the fore member 30a and secured to the aft member 30b, such that the second grid panel 52b superposed over the first grid panel 52a. The grid member 52 may optionally be secured to the floor 26 of the cargo bay 14. In this configuration, the grid member 52 may thereby function as a storage divider, extending between the top bar 42 of the aft member 30b and the floor 26 of the cargo bay 14.

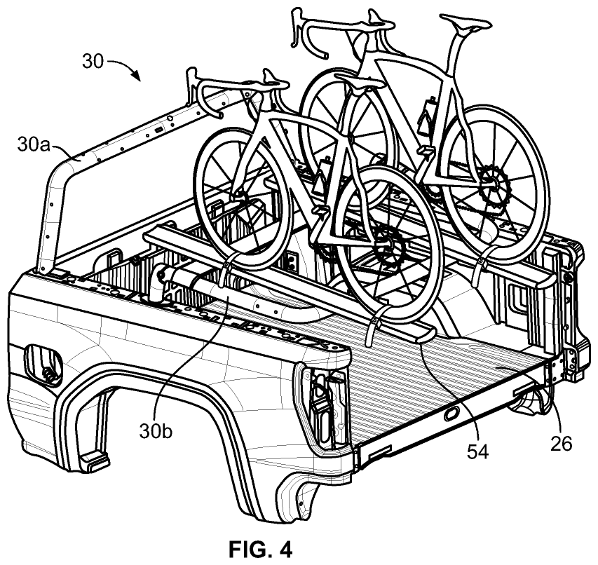

Referring now to FIG. 4, the accessory 30 may be provided with a storage rack 54 coupled to the aft member 30b. When the aft member 30b is disposed in the aftward position, as illustrated in FIG. 4, items may be secured to the storage rack 54 for transport, while still maintaining a usable cargo area between the aft member 30b and the floor 26 of the cargo bay 14. In the illustrated embodiment the storage rack 54 comprises a bicycle rack adapted to hold one or more bicycles; however, in other considered embodiments the storage rack 54 may be adapted to hold other items. Advantageously, in this configuration the fore member 30a provides a buffer between any stored items and the aft window 16.

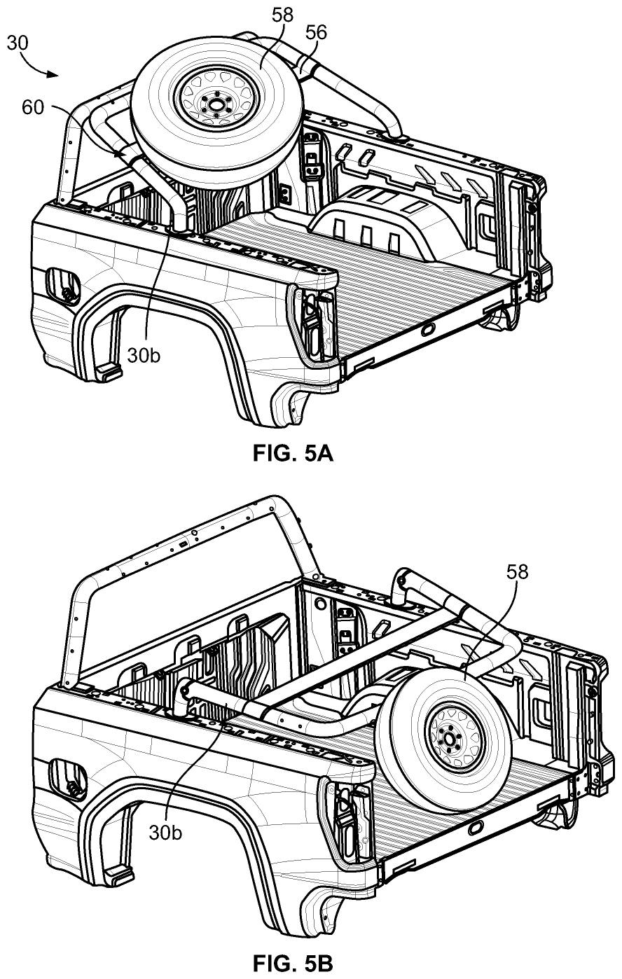

Referring now to FIGS. 5a and 5b, the accessory 30 may be provided with a tire storage system 56 for storing a spare tire 58. The tire storage system 56 comprises a longitudinal member 60 which may support the spare tire 58 when the aft member 30b is disposed in the forward position, as illustrated in FIG. 5a. The spare tire 58 is pivotably coupled to the top bar 42 of the aft member 30b, such that when the aft member 30b is moved to the aftward position, as illustrated in FIG. 5b, the spare tire 58 may pivot toward the aft of the cargo bay 14 for improved operator access.

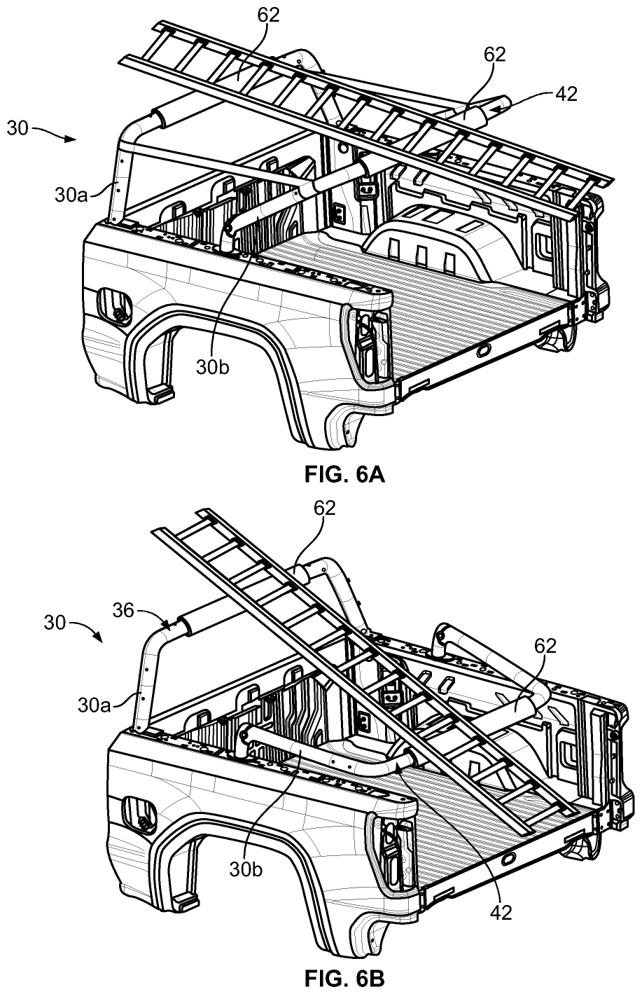

Referring now to FIGS. 6a and 6b, the accessory 30 may be provided with one or more roller members 62, e.g. a first roller member 62 associated with the top bar 36 of the fore member 30a and a second roller member 62 associated with the top bar 36 of the aft member 30b. The roller members 62 may comprise any suitable arrangement for enabling relative rotation between the exterior of the roller member 62 and the accessory 30, such as a tubular housing with a bearing disposed therein. Advantageously, such roller members 62 may facilitate loading of elongate objects such as ladders when the aft member 30b is moved to the aftward position, as illustrated in FIG. 6b. Moreover, the roller members 62 may be provided with a locking member such as a retaining pin to restrict relative rotation between the roller members 62 and the accessory 30. Advantageously, any stored objects may be more securely held in place when the aft member 30b is moved to the forward position, as illustrated in FIG. 6a.

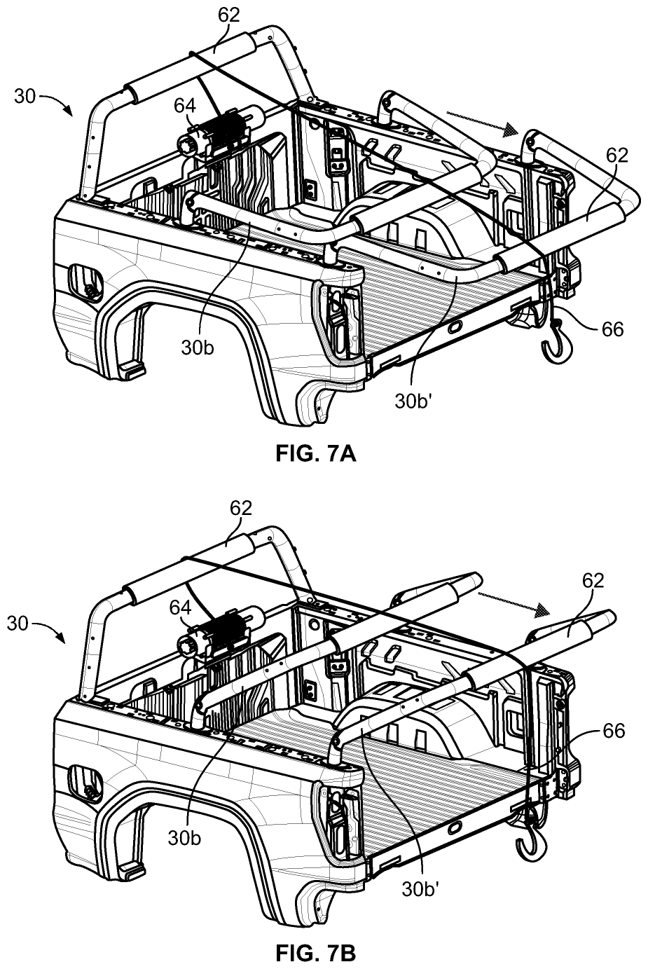

Referring now to FIGS. 7a and 7b, the accessory 30 may be further provided with a winch 64 having a cable 66. The winch 64 may be secured to the cargo area 14 as illustrated in FIG. 7a, secured to the fore member 30a, or otherwise operable in conjunction with the accessory 30. Advantageously, the cable 66 may be routed via the roller members 62 in with the aft member 30a in the intermediate position, as illustrated in FIG. 7a, or the aftward position, as illustrated in 7b, to achieve a desired angle depending on a particular use case. Moreover, the aft member 30b may optionally be installed further aftward relative to the cargo area 14 in a configuration 30b′, as illustrated in FIGS. 7a and 7b, to further achieve a desired angle of the cable 66.

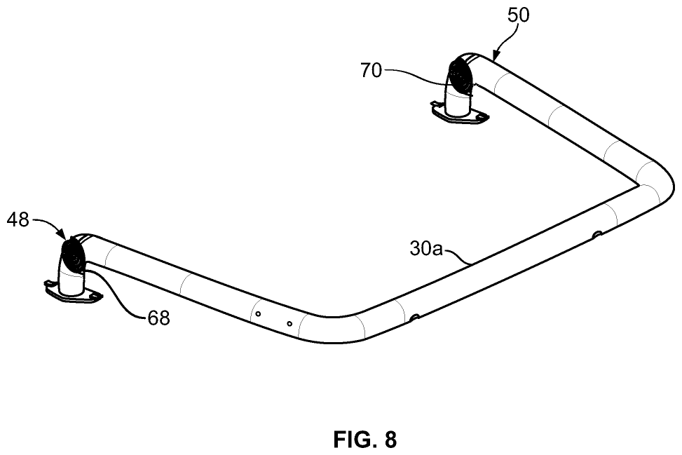

Various mechanisms may be used to secure the aft member 30b in a desired position from among the forward position, intermediate position, and aftward position. In an exemplary embodiment, a retention member, e.g. a retention pin, may be used to secure the aft member 30b in a desired position. In another exemplary embodiment, illustrated in FIG. 8, a first clock spring 68 is associated with the first pivoting connection 48 and a second clock spring 70 is associated with the first pivoting connection 50. In such embodiments, the clock springs 68, 70 may provide a counterbalance to facilitate motion of the aft member 30b among the various positions. Such embodiments may be integrated with gearing elements to enable a crank or motor to actuate the aft member 30b among the various positions. Such embodiments may also be provided with a retention member to secure the aft member 30b in a desired position.

As may be seen, the present disclosure provides a multi-function accessory capable of fulfilling multiple functional roles, and moreover does so via an easily reconfigurable assembly.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a cab having a window;
a cargo area proximate the cab, the cargo area having a first sidewall and a second sidewall;
a first accessory member coupled to the first sidewall and the second sidewall, the first accessory member extending about a portion of a periphery of the window;
a second accessory member pivotably coupled to the first sidewall and the second sidewall, the second accessory member comprising a first leg member, a second leg member, and a horizontal member, the first leg member having a first leg member proximal end and a first leg member distal end, the second leg member having a second leg member proximal end and a second leg member distal end, the first leg member proximal end being coupled to the first sidewall, the second leg member proximal end being coupled to the second sidewall, the horizontal member coupling the first leg member distal end to the second leg member distal end;
wherein the second accessory member is pivotable between first, second, and third positions relative to the cargo area, wherein in the first position the horizontal member is disposed proximate the first accessory member, in the second position the first leg member and the second leg member extend generally parallel to the first sidewall and the second sidewall, respectively, and wherein the third position is intermediate the first and second positions.

2. The vehicle of claim 1, further comprising a grid member having a first grid panel and a second grid panel with a folding interface therebetween, the first grid panel being coupled to the first accessory member, the second grid panel being coupled to the second accessory member.

3. The vehicle of claim 1, further comprising a roller member rotatably coupled to the horizontal member.

4. The vehicle of claim 1, further comprising a tire storage member coupled to the second accessory member.

5. The vehicle of claim 1, wherein the first leg member comprises a first articulated connection proximate the first leg member proximal end, the second leg member comprises a second articulated connection proximate the second leg member proximal end, and wherein the second accessory member is pivotably coupled to the first sidewall and the second sidewall via the first articulated connection and second articulated connection, respectively.

6. The vehicle of claim 5, further comprising a first engagement member associated with the first articulated connection and a second engagement member associated with the second articulated connection, the first engagement member and second engagement member being configured to selectively retain the second accessory member in a desired position among the first position, the second position, and the third position.

7. The vehicle of claim 5, further comprising a first clock spring associated with the first articulated connection and a second clock spring associated with the second articulated connection.

8. An accessory for a vehicle comprising:
a first tubular member configured to couple to first and second sidewalls of a cargo area, the first tubular member having a first leg member, a second leg member, and a first horizontal member coupling the first leg member to the second leg member;
a second tubular member configured to couple to first and second sidewalls of a cargo area spaced from the first tubular member, the second tubular member comprising a third leg member, a fourth leg member, and a second horizontal member, the third leg member having a third leg member proximal end, a third leg member distal end, and a first articulated connection disposed between the third leg member proximal end and the third leg member distal end, the fourth leg member having a fourth leg member proximal end, a fourth leg member distal end, and a second articulated connection disposed between the third leg member proximal end and the third leg member distal end, the second horizontal member coupling the third leg member distal end to the fourth leg member distal end;
wherein the second tubular member is pivotable between first, second, and third positions about the first and second articulated connections, wherein in the first position the second horizontal member is disposed proximate the first tubular member, in the second position the third leg member and the fourth leg member extend generally orthogonal to the first leg member and the second leg member, respectively, and wherein the third position is intermediate the first and second positions.

9. The accessory of claim 8, further comprising a grid member having a first grid panel and a second grid panel with a folding interface therebetween, the first grid panel being coupled to the first tubular member, the second grid panel being coupled to the second tubular member.

10. The accessory of claim 8, further comprising a roller member rotatably coupled to the second horizontal member.

11. The accessory of claim 8, further comprising a tire storage member coupled to the second tubular member.

12. The accessory of claim 8, further comprising a first engagement member associated with the first articulated connection and a second engagement member associated with the second articulated connection, the first engagement member and second engagement member being configured to selectively retain the second tubular member in a desired position among the first position, the second position, and the third position.

13. The accessory of claim 8, further comprising a first clock spring associated with the first articulated connection and a second clock spring associated with the second articulated connection.
